(19) United States
(12) Patent Application Publication
(10) Pub. No.: US 2016/0165063 A1
(43) Pub. Date: Jun. 9, 2016

(54) Enhanced Landline Telephone System With Mobile Telephone Functions

(71) Applicant: Christine Farmer, North Myrtle Beach, SC (US)

(72) Inventor: Christine Farmer, North Myrtle Beach, SC (US)

(21) Appl. No.: 14/564,732

(22) Filed: Dec. 9, 2014

(51) Int. Cl. H04M 7/12; H04M 3/42; H04W 4/14

(52) U.S. Cl. CPC H04M 7/1205; H04W 4/14; H04M 3/42382

(57) ABSTRACT

An enhanced landline telephone system for sending and receiving audible and data messages on landline, mobile phone, and wide area networks includes a landline telephone apparatus in data communication with a packet switch network. The packet switch network is configured to selectively communicate with a landline telephone, a mobile telephone, and a computer connected to the wide area network. The landline telephone apparatus includes a SMS module, a processor, and a memory in data communication with processor and SMS module. The memory includes programming and data structures configured to store data messages and audio/visual data associated therewith. There is programming that when executed by the processor causes the processor to deliver entered data messages to the packet switch network for delivery to target recipients on a respective landline, mobile phone, or wide area network, respectively.

### BACKGROUND OF THE INVENTION

This invention relates generally to telecommunications systems and, more particularly, to an enhanced landline telephone system having a landline telephone apparatus configured to send and receive audible and data messages on landline, mobile phone, and wide area networks.

Traditional residential and office telephones operate using a cable that interfaces a handset and input buttons to a public switch network in order to make voice calls to other landline telephones or, more recently, to mobile telephones. More recently, the advent of mobile telephones has brought the capability to send small text messages between mobile telephones. While landline telephones have an advantage over cell phones with regard to reliability and no dropped calls, cell phones have the advantage of SMS messaging and many other unique features. Computer messaging methods, such as email, also have advantages over both landline and mobile communications in that more complex combinations of media types can be sent by electronic mail over a wide area network such as the internet.

Therefore, it would be desirable to have an enhanced landline telephone apparatus having its traditional reliability but that also has SMS text messaging and computer network messaging. Further, it would be desirable to have an enhanced landline telephone apparatus having the capability to deliver predetermined text messages to predetermined or programmed target recipients such as emergency authorities. In addition, it would be desirable to have an enhanced landline telephone system having a camera and a USB port such that media contact from other electronic devices may be included with data messages generated by the landline telephone apparatus.

### SUMMARY OF THE INVENTION

An enhanced landline telephone system for sending and receiving audible and data messages on landline, mobile phone, and wide area networks according to the present invention includes a landline telephone apparatus in data communication with a packet switch network. The packet switch network is configured to selectively communicate with a landline telephone, a mobile telephone, and a computer connected to the wide area network. The landline telephone apparatus includes a SMS module, a processor, and a memory in data communication with processor and SMS module. The memory includes programming and data structures configured to store data messages and audio/visual data associated therewith. There is programming that when executed by the processor causes the processor to deliver entered data messages to the packet switch network for delivery to target recipients on a respective landline, mobile phone, or wide area network, respectively.

Having a landline phone that includes the versatility of mobile phone and email messaging features has many advantages, such as not needing to pay for multiple cell phones for children and the accompanying insurance fees, reducing the number and frustration of “dropped calls,” and being able to construct and deliver emergency text messages directly to authorities when needed.

Therefore, a general object of this invention is to provide an enhanced landline telephone system that includes a landline telephone apparatus configured to construct and transmit text messages.

Another object of this invention is to provide an enhanced landline telephone system, as aforesaid, that selectively interfaces with landline, mobile phone, and wide area networks so as to deliver voice and data messages.

Still another object of this invention is to provide an enhanced landline telephone system, as aforesaid, in which a landline telephone apparatus includes having a USB port configured to selectively associate digital content with a data message.

Yet another object of this invention is to provide an enhanced landline telephone system, as aforesaid, in which a landline telephone apparatus includes a camera configured to generate image data for association with text or other data.

A further object of this invention is to provide an enhanced landline telephone system, as aforesaid, in which the landline telephone apparatus includes present input buttons that selectively associate a text message with a target recipient such that emergency message or the like can be directly and immediately forwarded.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a landline telephone apparatus for use with a an enhanced landline telephone system according to a preferred embodiment of the present invention;

FIG. 2 is another perspective view of the landline telephone apparatus as in FIG. 1 illustrated with the display in a raised configuration;

FIG. 3 is a rear perspective view of the landline telephone apparatus as in FIG. 1;

FIG. 4 is another perspective view of the landline telephone apparatus as in FIG. 1 illustrating an embodiment with a touch screen keyboard;

FIG. 5 is a block diagram of the enhanced landline telephone system according to a preferred embodiment of the present invention;

FIG. 6 is a flowchart illustrating an exemplary process of use of the enhanced landline telephone system in operation;

FIG. 7 is a flowchart of a process for generating a data message using the enhanced landline telephone system of FIG. 5; and

FIG. 8 is a flowchart of a process for setting preset input buttons according to the present invention.

### DESCRIPTION OF THE PREFERRED EMBODIMENT

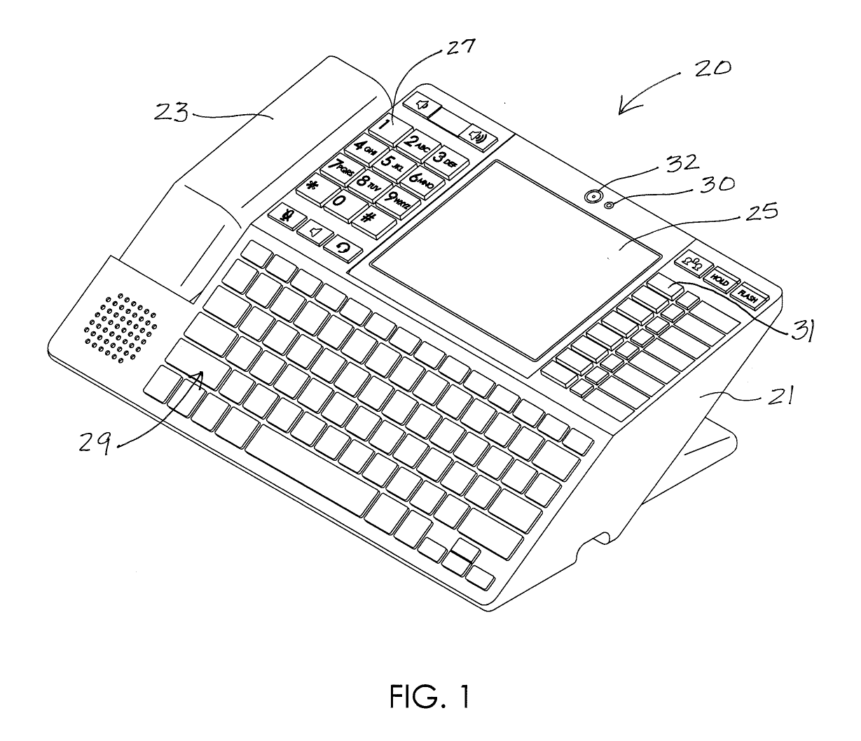

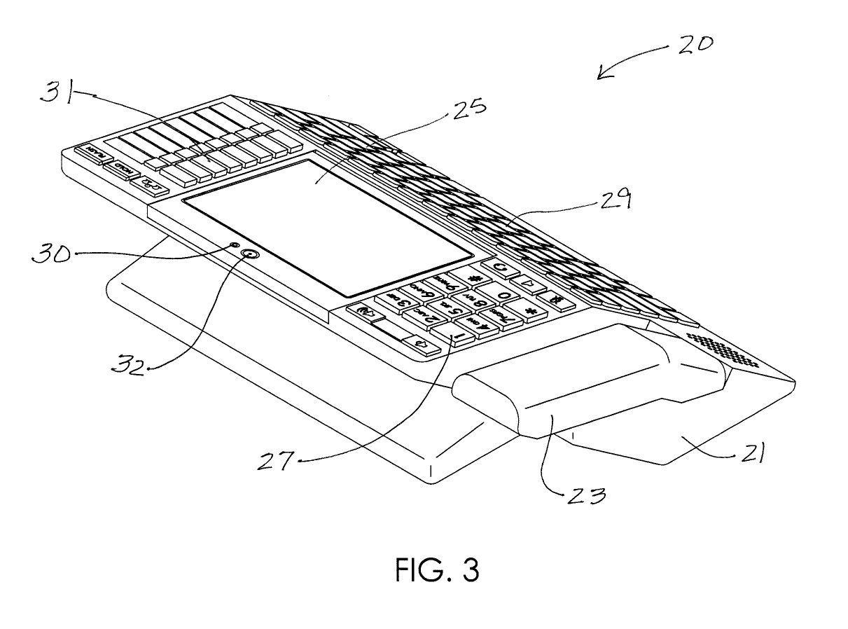

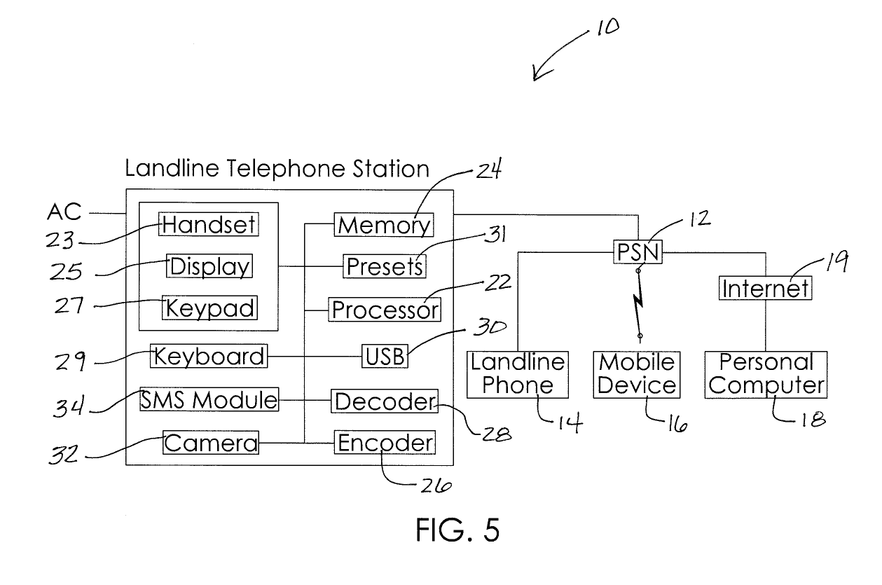

An enhanced landline telephone system for sending and receiving audible and data messages from a landline telephone apparatus over landline, mobile phone, and wide area networks will now be described in detail with reference to FIGS. 1 to 8 of the accompanying drawings.

The enhanced landline telephone system 10 includes a landline telephone apparatus 20 in communication with a packet switch network 12 (“PSN”). Packet switching is a digital network communications method in which all transmitted data is grouped into predetermined sized blocks called packets and facilitates transmitting streams of packets over a shared network. Data of all types, contents, and bit-rates can be streamed as packets. So, in the case of the present landline telephone apparatus 20, messages may be divided into groups or packets and delivered in an orderly fashion by the packet switch network 12 onto a landline network 14, mobile phone network 16 (e.g. cellular network), or wide area network 18 (e.g. the internet). The landline telephone apparatus 20 is capable of gaining access to these networks through its connection to a standard phone outlet.

The landline telephone apparatus 20 includes a case 21. A processor 22 and a memory 24 in data communication with the processor 22 may be situated in the interior area of the case 21. The memory 24 includes data structures configured to store data (such as for messages, target recipient data, and the like) and programming instructions. The processor 22 is in data communication with various input devices as will be described below that, individually or together, allow message data to be entered, processed, transmitted, displayed, and the like. In addition, the landline telephone apparatus 20 includes an encoder 26 configured to encode a message into digital packets to be streamed and a decoder 28 configured to decode incoming digital packets into a form that can be displayed or processed. The encoder 26 and decoder 28 may be situated in the case 21. In another embodiment, the packet switch network 12 may be situated remote from the telephone apparatus 20, such as at the PSN, and in data communication with the processor 22 and configured to receive input data or data stored in memory 24 and to encode it for transmission.

The packaging of messages into digital packets and access to landline, mobile phone, and wide area networks enables the landline telephone apparatus 20 to send and receive audible messages as is traditional by landline phones, text and image messages as is capable by cell phones, and combined data messages as is capable through electronic mail. In addition, the present invention discloses a landline phone apparatus 20 that can form data messages in a manner not previously disclosed by a landline device such as having data communication through a USB port 30, having a camera 32, being configured to receive digital content, and having other input elements, as will be described in greater detail below.

As indicated above, the landline telephone apparatus 20 includes a housing or case 21 defining an interior area configured to receive traditional telephone electronic components as well as components for operation like a mobile telephone and like a computer as will be described below. For instance, the landline telephone apparatus 20 includes a Short Messaging System module 34 (“SMS”) that enables text messages to be received, to be entered from input components, and to be transmitted through the mobile phone network 16 as will be described later. SMS is a text messaging service that uses known communication protocols to exchange short text messages primarily between mobile handsets.

Traditional telephone components may be coupled to the case 21, such as a handset 23, a display 25, and a numeric keypad 27. The handset 23 enables a user to hear audible messaging and to speak audible tones (such as a real time phone conversation) in a traditional manner. The keypad 27 may be used to enter either a landline or a mobile phone number. The numeric keypad 27 is an input device by which a telephone number may be entered. Entry of a telephone number is indicative of a “target recipient” of a message. The keypad 27 may be positioned on an upper surface of the case 21 as shown in the drawings or be positioned on the handset 23 or another location on the case 21.

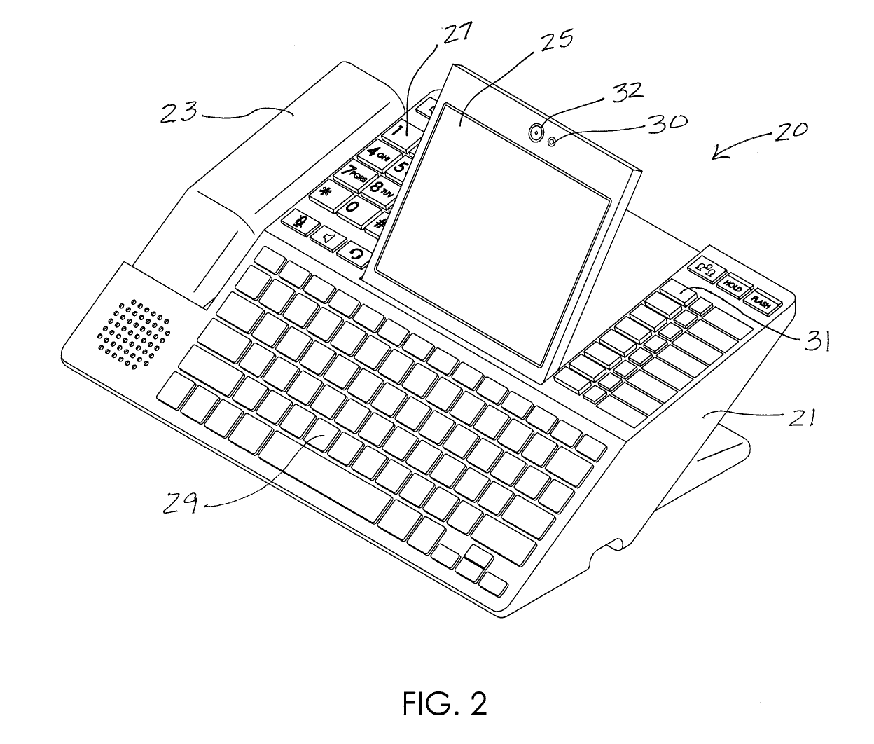

The display 25 is configured to publish numbers being entered into the keypad, caller-ID information from an incoming call, a text message being composed or received, or the like. In an embodiment, the display 25 may be pivotally coupled to a top surface of the case 21 and movable between a stowed configuration (FIG. 1) and a raised configuration (FIG. 2) displaced from the upper surface of the case 21. It is understood that text or images displayed on the display 25 may be more readable when the display is pivoted to the raised configuration.

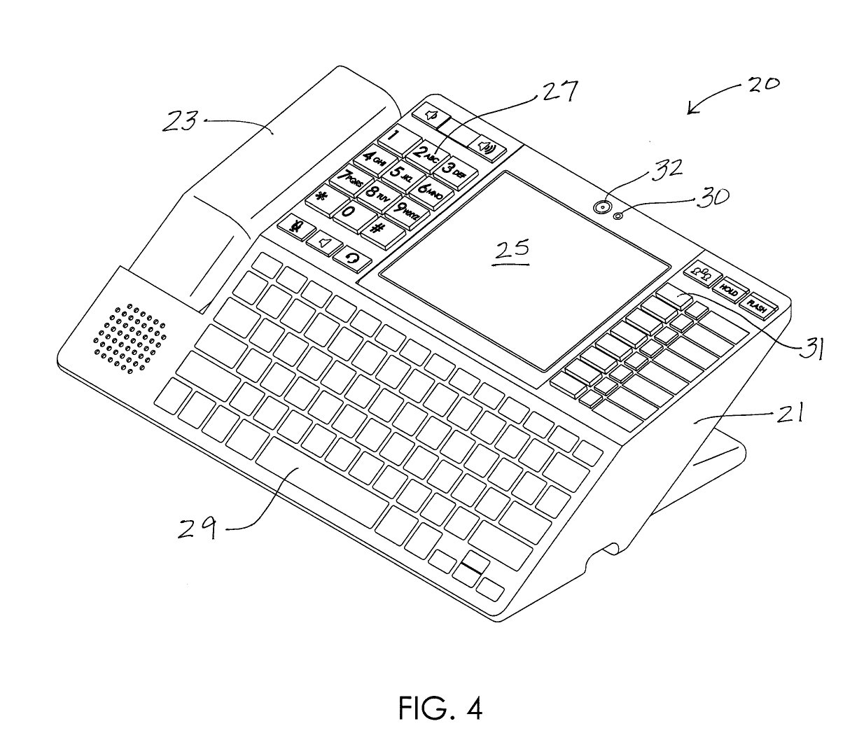

In an embodiment, a keyboard 29 may be included as an input device and situated on the case 21 (FIG. 1). The keyboard 29 may include traditional keys or may be in the form of a touch screen (FIG. 4). In an embodiment, the landline telephone apparatus 20 may include a plurality of preset input buttons 31 (FIG. 1). The plurality of preset input buttons 31 may be situated on an upper surface of the case 21. Each preset input button 31 is electrically connected to the processor 22 and may be associated with a predetermined target recipient (e.g. telephone number, email address, or the like) or may be programmed to be associated with a target recipient. Further, a plurality of target recipients and associated contact addresses may be stored in respective data structures in the memory 24 and each target recipient may be associated with a respective preset input button 31. Still further, a predetermined data (text) message indicative of an emergency condition may be associated with a preset input button and associated target recipient. For instance, a message indicative of a home invasion may be associated with a preset input button and target recipient. In such instance, pressing the preset input button would call the target recipient, such as 9-1-1, and deliver the emergency message, e.g. “I am being robbed. Need Police NOW.”

The landline telephone apparatus 20 may include a USB port 30 in communication with the processor 22 and, operatively, with the memory 24. The USB port is selectively connected to an electronic device (not shown) remote from the landline telephone apparatus 20. For instance, a flash drive, portable hard disk drive, laptop computer, tablet computing device, electronic music player, or the like may be electrically connected to the USB port 30 and thus in data communication with the processor 22 of the landline telephone apparatus 20. Executing programming instructions, the processor 22 is able to associate data received via the USB port 30 with text and data messages entered with respective input devices. The combined data message (text and data from a USB connected device) may then be transmitted through the packet switch network 12 and connected networks.

The landline telephone apparatus 20 may include a camera 32 mounted to the case 21 or, more particularly, to the pivotal display 25. Preferably, the camera 32 is in data communication with the processor 22 and, operatively, to the memory 24. The camera 32 enables a user to snap a picture of himself when positioned in front of the display 25 in the manner of a “selfie.” Under program control, a picture may be taken by the camera 32 and saved in a respective data structure in memory 24. The combined data message may then sent by the SMS module 34 via the mobile phone network 16 or as an attachment to an email message transmitted over the wide area network 18, such as the internet 19.

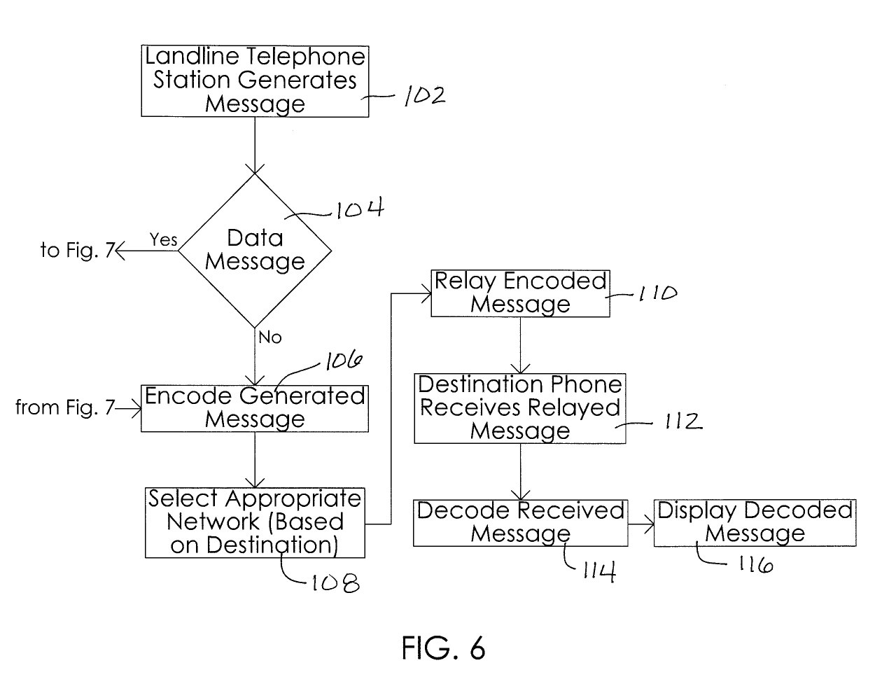

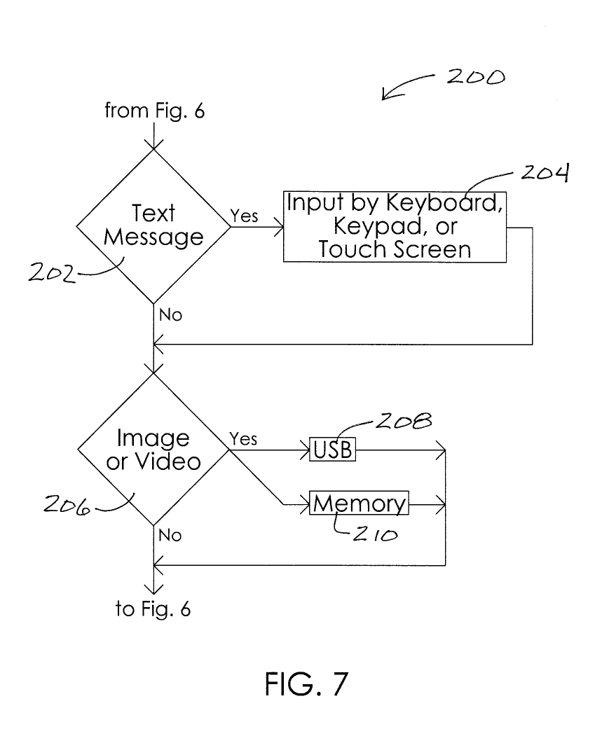

An exemplary process 100 of operation of the enhanced landline telephone system 10 according to the present invention is shown in FIGS. 6 to 8. At step 102, a message is generated. This message may be a voice message being transmitted as a traditional landline voice message or indicative of a desire to construct a data message entered via the input devices such as the keyboard 29, keypad 27, USB port 30, camera 32, or the like. The process 100 proceeds to step 104. At step 104, the processor 22 determines if a user desires to construct a data message and, if so, proceeds to the process shown in FIG. 7 as will be described later. Otherwise, the process 100 proceeds to step 106.

At step 106, the message having been processed according to the process shown in FIG. 7 is encoded into digital packets by the SMS module 34 or, alternately by an encoder 26 in data communication with the processor 22 as described above. The process 100 proceeds to step 108. At step 108, the appropriate network upon which the encoded message will be transmitted is determined based on the address of the target recipient. More particularly, the processor 22 is configured to determine if the target is a landline number, mobile phone number, or an email address. The appropriate network (landline, mobile phone, or wide area network is connected through an appropriate interface. The process 100 proceeds to step 110.

At step 110, the encoded message is relayed or transmitted via the network determined to be appropriate. The process 100 proceeds to step 112. At step 112, a destination target recipient receives the relayed message and the process 100 proceeds to step 114. It is represented at step 114 that a received message (such as by the landline telephone apparatus 20) is decoded by the decoder 28 into a complete intelligible message. The process 100 proceeds to step 116 where the decoded message is published on the display 25.

Now turning to FIG. 7, a process 200 is provided for assembling a data message. Process 200 is initiated from step 104 illustrated in FIG. 6 which sends control to step 202. At step 202, the processor 22 under program control determines if a data message to be formed is to be a text message and, if so, the process 200 proceeds to step 204. Otherwise, the process 200 proceeds to step 206. At step 204, data is received from an input device such as the keyboard 29 or keypad 27 and then control is passed to step 206.

At step 206, the processor 22 determines if an image, video, or other media is to be attached to a text message and, if so, proceeds in turn to steps 208 and 210. Otherwise, the process 200 proceeds to step 106 illustrated in FIG. 6. At steps 208 and 210, a user is given opportunity to access the contents of an electronic device connected to the landline telephone apparatus 20 via the USB port 30 or to access a file previously stored in memory 24, so as to attach an image, video, picture, or the like to a text message. The process 200 then returns to step 106 illustrated in FIG. 6 and described previously.

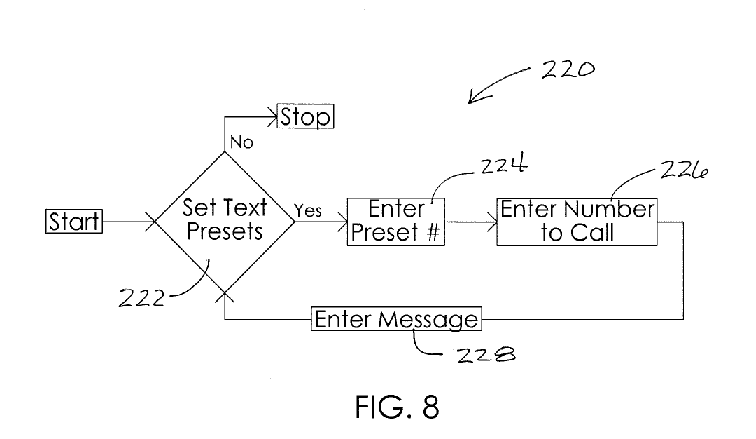

FIG. 8 illustrates a process 220 directed to managing the preset input buttons 31 described previously. At step 222, the processor 22 determines if a text message is to be associated with a respective preset input button 31 and, if so, the process proceeds to step 224. Otherwise, the process 220 ends. At step 224, a user is allowed to enter or specify which preset input button 31 is to be associated with a message. The process 220 then proceeds to step 226 where the user enters a telephone number or contact address of a target recipient associated with the preset message. The process 220 then proceeds to step 228 where a user enters the text of the message associated with the preset input button 31. The process 200 returns to step 222 where more preset input buttons 31 may be similarly programmed.

In use, the landline telephone apparatus 20 may be situated virtually anywhere in a home or office, connected to a traditional telephone landline, and utilized for voice calls in a traditional manner. As with a traditional landline phone, calls may be placed to both landline (cord or cordless) and wireless mobile phones. In the present invention, however, the landline telephone apparatus 20 also includes an SMS module 34 capable of generating and sending text messages in the manner common to cell phone technology. Text messages may be composed using various input devices such as a keyboard or keypad situated on the case 21 of the landline telephone apparatus 20. The processor 22 determines whether a message is to be sent via a traditional landline network 14, mobile phone network 16, or wide area network 18 based on the nature of the target recipient address.

Importantly, the landline telephone apparatus 20 includes several features that are unexpected of a residential or office landline phone. Namely, the landline telephone apparatus 20 includes a USB port 30, a camera 32, and a memory 24 configured to store media files obtained from the USB port 30 and camera 32 components such that said files may be attached to outbound data messages.

It is understood that while certain forms of this invention have been illustrated and described, it is not limited thereto except insofar as such limitations are included in the following claims and allowable functional equivalents thereof.

1. An enhanced landline telephone system for sending and receiving audible and data messages on landline, mobile phone, and wide area networks, comprising:
a landline telephone apparatus in data communication with a packet switch network;
wherein:
said packet switch network is configured to selectively communicate with a landline telephone, a mobile telephone, and a computer connected to the wide area network;
said landline telephone apparatus includes a short message service (“SMS”) module, a processor, and a memory in data communication with said processor and said SMS module;
said memory includes programming and data structures configured to store data messages and audio/visual data associated with said data messages;
said landline telephone apparatus includes an input device configured to enter a data message and a target recipient from a user;
programming in said memory that, when executed by said processor, causes said processor to deliver said entered data message to said packet switch network for delivery to a selected recipient on a respective landline, mobile phone, or wide area network, respectively.

2. The enhanced landline telephone system as in claim 1, wherein said packet switch network connects to the mobile phone network if said target recipient is indicative of a mobile phone number.

3. The enhanced landline telephone system as in claim 2, wherein said packet switch network connects to the wide area network if said target recipient is indicative of an email address.

4. The enhanced landline telephone system as in claim 3, wherein said landline telephone apparatus includes a decoder configured to decode an incoming digital message and an encoder configured to encode an outgoing digital message in data communication with said SMS module.

5. The enhanced landline telephone system as in claim 1, wherein said input device includes a keyboard in data communication with said processor.

6. The enhanced landline telephone system as in claim 1, wherein said input device includes a camera in data communication with said processor.

7. The enhanced landline telephone system as in claim 1, wherein said landline telephone apparatus includes a handset and a display in data communication with said processor, said display configured to publish said entered message and to publish an incoming message.

8. The enhanced landline telephone system as in claim 7, wherein said handset includes a keypad having a plurality of numeric keys configured to enter a number indicative of said target recipient.

9. The enhanced landline telephone system as in claim 8, wherein said landline telephone apparatus includes a plurality of preset input buttons in communication with said processor, each preset input button being associated with a user-determined target recipient.

10. The enhanced landline telephone system as in claim 1, comprising a USB port in data communication with said processor and said memory, said USB port configured to receive message data from a remote electronic device and selectively associated with said entered data message.

11. The enhanced landline telephone system as in claim 1, comprising a camera in data communication with said processor and said memory, said camera configured to receive message data from a remote electronic device and selectively associated with said entered data message.

12. The enhanced landline telephone system as in claim 3, comprising a USB port in data communication with said processor and said memory, said USB port configured to receive message data from a remote electronic device and selectively associated with said entered data message.

13. The enhanced landline telephone system as in claim 12, comprising a camera in data communication with said processor and said memory, said camera configured to receive message data from a remote electronic device and selectively associated with said entered data message.

14. The enhanced landline telephone system as in claim 1, comprising:
a case defining an interior area configured to house said processor, said memory, and said SMS module;
a handset and a display operatively coupled to said case and in data communication with said processor, said display configured to publish said entered message and to publish an incoming message;
wherein said input device is a keyboard situated on an outer surface of said case and in data communication with said processor.

15. The enhanced landline telephone system as in claim 14, comprising a USB port situated on said case and in data communication with said processor and said memory, said USB port configured to receive message data from a remote electronic device and selectively associated with said entered data message.

16. The enhanced landline telephone system as in claim 15, comprising a camera situated on said case and in data communication with said processor and said memory, said camera configured to receive message data from a remote electronic device and selectively associated with said entered data message.

17. The enhanced landline telephone system as in claim 9, wherein:
a respective data structure in said memory includes a predetermined data message indicative of an emergency condition; and
a respective preset button is associated with a target recipient of an emergency response agency; and
programming in said memory that when executed by said processor causes said processor to relay said predetermined data message indicative of an emergency condition to said target recipient.

18. The enhanced landline telephone system as in claim 13, wherein:
said landline telephone apparatus includes a plurality of preset input buttons in communication with said processor, each preset input button being associated with a user-determined target recipient;
a respective data structure in said memory includes a predetermined data message indicative of an emergency condition; and
a respective preset button is associated with a target recipient of an emergency response agency; and
programming in said memory that when executed by said processor causes said processor to relay said predetermined data message indicative of an emergency condition to said target recipient.
